(19) United States
(12) Patent Application Publication
(10) Pub. No.: US 2015/0321306 A1
(43) Pub. Date: Nov. 12, 2015

(54) SYSTEM TO SUPPORT MACHINABLE PLATES DURING MACHINING PROCESS

(71) Applicant: Caterpillar Inc., Peoria, IL (US)

(72) Inventors: Yujie Chen, Peoria, IL (US); Thimmaiah K. Ganapathi, Peoria, IL (US); Michael H. Noble, Peoria, IL (US); Rohit A. Bhapkar, Peoria, IL (US)

(73) Assignee: Caterpillar Inc., Peoria, IL (US)

(21) Appl. No.: 14/807,889

(22) Filed: Jul. 24, 2015

(51) Int. Cl. B23Q 17/00; B23Q 3/06; B23Q 17/09

(52) U.S. Cl. CPC B23Q 17/005; B23Q 17/0976; B23Q 3/065

(57) ABSTRACT

A support system to support a work piece is disclosed. The work piece has at least one machineable plate and at least one fixture-stabilizing portion. The support system includes a support device for insertion between the machineable plate and the fixture-stabilizing portion. The support device includes a first support member with a first end and a second end. A channel extends from the first end along a first direction. Further, a second support member is adjustably coupled to the first support member to adjust a length between the first end and an end of the second support member, distal to the first support member. A strain gauge unit is configured to indicate a force induced in the support device upon linear manipulation of the support device and when the support device is positioned and tightened against the machineable plate and the fixture-stabilizing portion.

### TECHNICAL FIELD

The present disclosure relates generally to a system to support relatively large thin walled machineable plates and easy to self-excited components, like thin wall structures, during machining processes. More specifically, the present disclosure relates to an adjustable support system that is positionable against large structural components and structures to avoid generation of tool vibration (chatter) during machining operations.

### BACKGROUND

Several applications in the construction machine industry involve machining of work pieces. Work pieces may constitute one or more machineable plates, also referred to as thin-wall structures. Such structures generally lack sufficient static rigidity, requisite stiffness, damping, and dynamic stability, to withstand cutting forces of a machining process. During machining operations, dynamic instability in thin walls is liable to be induced due to a self-excited vibration, generally known as chatter. Chatter is observable between the cutting-tool and the work piece, and is generally the cause of product quality related problems. Typically, such conditions result from insufficient support provisions and limited damping capabilities of thin-wall structures. As a result, problems affiliated with surface finish and irreversible deformations are usually sustained.

Generally, it is difficult to hold thin-wall structures in place during machining processes. Conventional methods to avoid chatter involve the placement of a support member, which is commonly welded to a portion of the thin wall, or the machineable plate, at one end, while another end of the fixture unit is generally welded to a fixture-stabilizing portion. After the machining process, this support member is removed from the work piece. This process leaves behind weld marks, burrs, and aberrations, on the surface of the work piece. This result is undesirable as welding generally involves an increased cycle time. Moreover, the quality of the work piece is typically severely affected, as well.

U.S. Pat. No. 8,960,456 B2 relates to an extension device, which is extendable along an associated length. This reference discloses an apparatus that involves a first shaft and a second shaft. Each shaft is rotatable relative to the other and is able to apply tension against an opposing abutment surface. However, a focus of the application is towards a single lock nut that's facilitates the locking of the tension rod in situ. Moreover, the disclosed apparatus is relatively bulky and complex. This leaves room for improvement in the provision of relatively less bulky and complex structures when a supposedly similar concept is applied to avoid chatter in thin wall applications. Additionally, it remains pertinent to at least gauge the tension applied between shafts, which may be demanding in conventional thin-wall-based machining operations.

Accordingly, the system and method of the present disclosure solves one or more problems set forth above and other problems in the art.

### SUMMARY OF THE INVENTION

Various aspects of the present disclosure illustrate a support system to support a work piece. The work piece has at least one machineable plate and at least one fixture-stabilizing portion. The system includes a support device adapted to be inserted between the at least one machineable plate and the at least one fixture-stabilizing portion. The support device includes a first support member with a first end and a second end. The first support member defines a channel that extends from the first end along a first direction. A second support member is adjustably coupled to the first support member. The second support member facilitates adjustment of a length between the first end and an end of the second support member, which is distal to the first support member. Further, a strain gauge unit indicates a force induced in the support device upon linear manipulation of the first support member relative to the second support member, is included. An indication by the strain gauge unit is established when the support device is positioned and tightened against the at least one machineable plate and the at least one fixture-stabilizing portion.

### BRIEF DESCRIPTION OF THE DRAWINGS

FIG. 1 is a perspective view of an exemplary work piece that includes a thin-wall structure, or machineable plates, and which is in operable assembly with a support system, in accordance with the concepts of the present disclosure;

FIG. 2 is a plan view of the support system of FIG. 1, with a partial cut-out section of a portion that illustrates a position of a strain gauge unit, in accordance with the concepts of the present disclosure; and

FIG. 3 is an enlarged view of the partial cut-out section of FIG. 2, which depicts components of the strain gauge unit of FIG. 2, in accordance with the concepts of the present disclosure.

### DETAILED DESCRIPTION

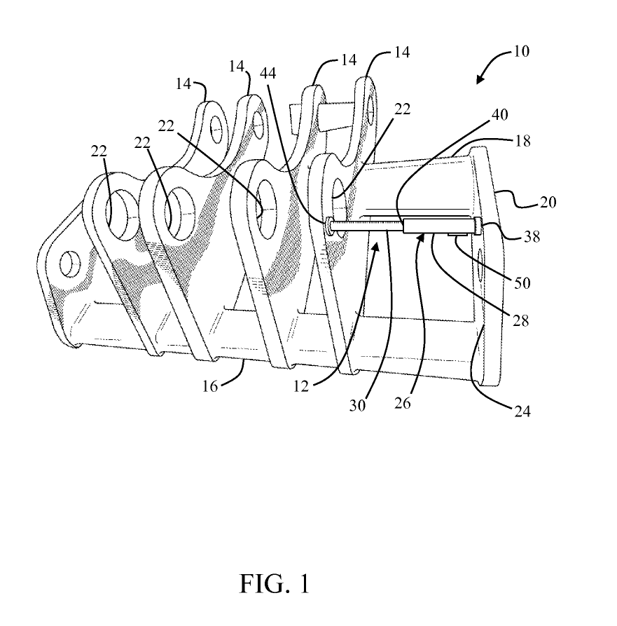

Referring to FIG. 1, there is shown an exemplary carriage assembly 10. The carriage assembly 10 is shown in conjunction with a support system 12, which supports the carriage assembly 10 during a machining process. The carriage assembly 10 is generally applied to a fork gp-pallet (not shown), which is usable in construction machines, such as a wheel loader (not shown). However, aspects of the present disclosure are applicable to a variety of components of conventional construction machinery that are structurally similar to the carriage assembly 10. Since machining may be performed on the carriage assembly 10, the carriage assembly 10 is also referred to as work piece 10.

The work piece 10 includes a number of relatively thin wall portions, which are termed as machineable plates 14, or simply plates 14. The work piece 10 also includes a pole portion 16, a support portion 18, and a base portion 20. The pole portion 16 and the support portion 18 (or simply portions 16 and 18) are generally elongated members that are parallely arranged to each other. To this end, the pole portion 16 and the support portion 18 integrally and contiguously pass through the plates 14, to support and form a rigid connection between the plates 14. Generally, the pole portion 16 and the support portion 18 are applicable for an end-use of the work piece 10. However, during a machining process, the pole portion 16 and the support portion 18 is also used to impart at least a minimum degree of stiffness to the work piece 10, and, more particularly, the plates 14.

The plates 14 are generally planar components that are sequentially and parallely arranged along an extension of the pole portion 16 and the support portion 18. Although four plates 14 are shown, the work piece 10 can have additional or fewer number of plates 14 to which aspects of the present disclosure may be suitably applied. Each plate 14 has one or more bores 22. The bores 22 are located on the plates 14 at a substantial distance from the portions 16 and 18. Given the parallel and sequential deployment of the each plate 14, the bores 22 are defined sequentially as well. Moreover, the bores 22 are also co-axially deployed relative to each other. In this manner, the plates 14 can be adapted to pivotally accommodate and support at least a rotatable shaft member (not shown), or an auxiliary member (not shown), so as to execute operations affiliated with the related construction machine (not shown) to which the work piece 10 is applied.

The base portion 20 defines a fixture-stabilizing portion 24, which acts as a reference to tighten and restrict at least one plate 14 from vibration during machining. The base portion 20 is structured adjacent to the plates 14. In this manner, the base portion 20 is able to act as a reference to which at least one plate 14 may be substantially immovably restrained by, for example, a fixture unit. In turn, the base portion 20 is positionable against a portion of a machine (not shown) that executes a machining operation. In so doing, the base portion 20 is deployed relatively rigidly for machining. Therefore, the base portion 20 includes a portion that serves as the fixture-stabilizing portion 24. Accordingly, the fixture-stabilizing portion 24 is an existing portion of the work piece 10.

The support system 12, which is adapted to reduce chatter in the plates 14 during a machining process, includes a support device 26. As shown in FIG. 1, the support device 26 is generally positionable and insertable between the fixture-stabilizing portion 24 of the base portion 20 and an adjacent plate 14. However, as each plate 14 is capable to act as a fixture-stabilizing portion, it may be contemplated that the support device 26 is generally positionable between two consecutively arranged plates 14 as well, with one of the plates 14 acting as a fixture-stabilizing portion. Moreover, since the disclosed embodiment illustrates four plates 14, embodiments may be contemplated where each consecutively arranged pair of plates 14 respectively accommodate the support device 26, so as to have each plate 14 (and the work piece 10) inflexibly and immovably positioned during a machining process.

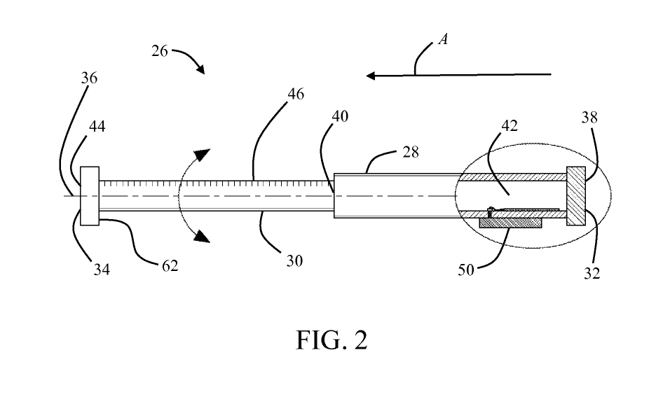

Referring to FIGS. 1 and 2, the support device 26 includes a first support member 28, a second support member 30, a first damper 32, and a second damper 34 (or simply dampers 32 and 34). The support device 26 is extendable and retractable linearly along an axis 36 of the support device 26. In so doing, the support device 26 is adapted to sustain compression as opposing ends of the support device 26 extend to abut and push against one of the plates 14 and the fixture-stabilizing portion 24, during operation.

Both the first support member 28 and the second support member 30 are substantially cylindrical devices. Moreover, the second support member 30 has a smaller cross-sectional area than a cross-sectional area of the first support member 28. Such a configuration enables the second support member 30 to be positioned within the channel 42 of the first support member 28, with the capability of having the second support member 30 rotatably supported relative to the first support member 28.

The first support member 28 includes a first end 38 and a second end 40, as shown. The first support member 28 includes a channel 42 (FIG. 2), which extends between the first end 38 and the second end 40, in a first direction, A. An inner wall 58 of the first support member 28 includes internal threads (not shown) that facilitate rotatable engagement with the external threads (not shown) of the second support member 30.

In an embodiment, the threads (not shown) may extend throughout the physical extent of the channel 42. However, it may also be contemplated that the threads (not shown) extend only partially into the channel 42 from the second end 40. In a fully collapsed condition, for example, an inner end (not shown), opposite to the end 44 of the second support member 30, may extend only up to an adjacent portion of a strain gauge unit 50 (FIG. 2) positioned within the first support member 28. In this manner, the second support member 30 may be restricted from a contact with the strain gauge unit 50, and damage to the strain gauge unit 50 from an interference of the second support member 30 may be avoided. Further, in this condition, the second end 40 of the first support member 28 may touch an inner face 62 (FIG. 2) of the damper 34. As a result, the damper 34 may act as a stopper to prevent further tightening of the first support member 28 relative to the second support member 30. Effectively, the threads on second support member 30 may extend throughout a length of the second support member 30, whereas the internal threads (not shown) on the first support member 28 may extend up to the strain gauge unit 50.

The second support member 30 is adjustably engaged with the first support member 28. This engagement is rotatably enabled and allows the second support member 30 to be adjustable in length relative to the first support member 28. The adjustment in length is facilitated between a first end 38 of the first support member 28, and an end 44 of the second support member 30 (or the support device 26), which is distal to the first support member 28. The second support member 30 includes scale 46, which facilitates visual analysis and measurement of an extent to which the second support member 30 has drawn back or forth relative to the first support member 28.

The dampers 32 and 34 are affixed to the support device 26 at either ends of the support device 26. To this end, the first damper 32 is attached to the first end 38 of the first support member 28, while the second damper 34 is attached to the end 44 of the second support member 30. In so doing, a vibration damped interface between the work piece 10 and the support device 26 is established by the dampers 32 and 34. Dampers 32 and 34 generally serve to prevent force transmissibility through the work piece 10 and thereby contribute to exacerbating the chatter from a machining operation. Dampers 32 and 34 are made from rubber, or from types of polymers, for example.

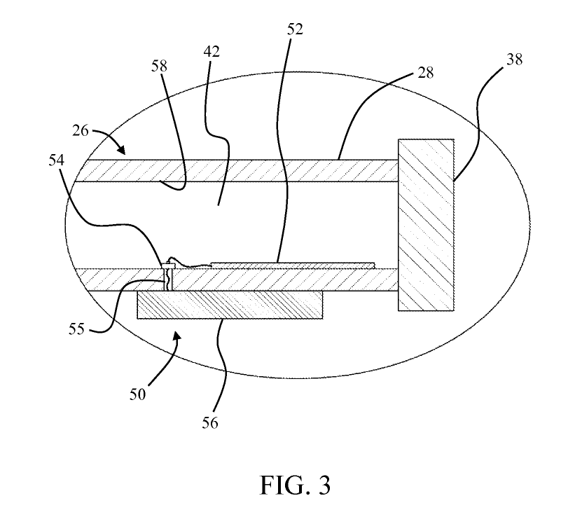

Referring to FIGS. 2 and 3, the support device 26 includes a strain gauge unit 50, which is configured to indicate a force induced in the support device 26. This force is imparted upon every linear manipulation of the first support member 28, relative to the second support member 30, when the support device 26 is positioned and tightened against the at least one plate 14 and the fixture-stabilizing portion 24. To this end, the strain gauge unit 50 includes a strain gauge 52, a data acquisition unit (DAQ) 54, and a force indicator 56, as shown.

The strain gauge 52 is generally used to measure strain (or a force of operation) on the support device 26. The strain gauge 52 has an insulating flexible base, which supports a metallic foil (not shown). The strain gauge 52 is attached to an inner wall 58 of the channel 42, by a suitable adhesive, such as cyanoacrylate, although other means of securement are possible. As the inner wall 58 is deformed during operation, the foil (not shown) of the strain gauge 52 is also deformed. This facilitates alteration of the electrical resistance of the foil (not shown). A Wheatstone bridge (not shown) determines a resulting change in resistance and facilitates the establishment of the strain induced in the inner wall 58 and the support device 26.

The DAQ 54 is generally mounted internally to the support device 26, within the channel 42. Further, the DAQ 54 is mounted on the inner wall 58 of the first support member 28. The DAQ 54 is in electrical connection with the strain gauge 52 through an annular opening 55 in the first support member 28. The DAQ 54 is an electrical assembly of a number of electrical components that receive and process electric signals, to output a relevant data that corresponds to the measurement of strain by the strain gauge 52. In an embodiment, the DAQ 54 is a microprocessor-based unit, which includes a built-in memory and logic. The built-in memory of the microprocessor of DAQ 54 can store the data related to the threshold force of support system 12. When the applied tension (or compression) in the support system 12 breaches the threshold data, the breach is detected by the built-in logic which prompts the DAQ 54 to facilitate an output alarm via a beep sound and a flashing visual display.

The force indicator 56 is a digital display that displays the force applied when the support device 26 is tensioned at either ends (first end 38 and end 44). The force indicator 56 displays the force in multiple formats and specified units, which is preset according to a preference. The display of force is pertinent to the ready observation of an operator, so as to allow the operator to take appropriate action when the threshold limit of tension is breached.

### INDUSTRIAL APPLICABILITY

Generally, the plate 14 may be required to facilitate lift and delivery of a freight, cargo, or other dump materials, at a worksite. Concomitantly, a substantial amount of load may be borne by the plates 14. This load may be sustained in the vicinity of the bores 22 as well as at an interface formed between the plates 14 and the portions 16 and 18. Although a rigidity and strength imparted by the portions 16 and 18 is generally sufficient to execute the laborious procedures of lifting and delivering a load, this rigidity may be generally insufficient to prevent chatter that is sustained during machining of the bores 22.

During an exemplary operation, and before the initiation of a machining operation, an operator first determines an approximate distance between the base portion 20 and the adjacent plate 14. Thereafter, the operator threadably adjusts the support device 26 preferably to a lesser length, than the determined distance. This scale 46 may assist in the attainment of this length of the support device 26. Next, the operator positions the first end 38 of the support device 26 against the fixture-stabilizing portion 24. A minimal gap that ought to remain between the end 44 and an associated portion of the adjacent plate 14 is threadably corrected by a further extension of the second support member 30, relative to the first support member 28, towards the plate 14.

Once the first end 38 and the end 44 are positioned respectively against the fixture-stabilizing portion 24 and the plates 14, the support device 26 is further tightened so as to robustly provide support to the plates 14 against the cutting forces of operation. As tightening is performed, strain is induced in the support device 26. This strain is detected by the strain gauge 52 and a corresponding strain signal is transmitted to the DAQ 54. The DAQ 54 processes and converts the strain signal into a compatible format for delivery unto the force indicator 56. When further tightened, the operator may note a breach of an associated force beyond a requisite degree by observing the force indicator 56. Such a breach may be either be outputted by the force indicator 56 as a digital display, via an audible alarm, or a combination of the two. Upon the receipt of this indication, the operator halts further tightening of the support device 26.

Thereafter, a machining operation is initiated to form the bores 22. Concurrently, the support system 12 provides the requisite stiffness against vibration and chatter of the plates 14. Optionally, a C-clamp (not shown) may be used to support the exterior of the plates 14 to prevent any excessive deformation. By applying the support system 12, the traditional process of welding fixture units against the plates 14 and the base portion 20 is annulled and a time associated with sourcing and welding the fixture units against the plates 14 is prevented. Moreover, quality of the plates 14 is maintained as attachment and removal of the conventional fixture unit is effectively avoided.

In the disclosed embodiment, an illustration pertaining to a first abutment of the first support member 28 relative to the fixture-stabilizing portion 24, and a second abutment of the second support member 30 relative to the plate 14 is shown. It is contemplated that applications may use multiple support devices, such as the support device 26, and position each support device 26 in between each subsequently arranged pair of plates 14. In so doing, the work piece 10 is made substantially rigid and a machining operation can be performed with a higher degree of accuracy and precision. Although a boring operation is envisioned with the present disclosure, the support device 26 may find use and incorporation in multiple other machining applications. Further, it also needs to be understood that an application involving the use of thin-wall structures is purely exemplary in nature.

It should be understood that the above description is intended for illustrative purposes only and is not intended to limit the scope of the present disclosure in any way. Thus, one skilled in the art will appreciate that other aspects of the disclosure may be obtained from a study of the drawings, the disclosure, and the appended claim.

What is claimed is:

1. A support system for supporting a work piece, the work piece having at least one machineable plate and at least one fixture-stabilizing portion, the system comprising:
a support device adapted to be inserted between the at least one machineable plate and the at least one fixture-stabilizing portion, the support device including:
a first support member having a first end and a second end, the first support member defining a channel extending from the first end along a first direction;
a second support member adjustably coupled to the first support member to adjust a length between the first end of the first support member and an end of the second support member distal to the first support member;
a strain gauge unit configured to indicate a force induced in the support device upon linear manipulation of the first support member relative to the second support member, when the support device is positioned and tightened against the at least one machineable plate and the at least one fixture-stabilizing portion.
